(19) United States
(12) Patent Application Publication
(10) Pub. No.: US 2021/0188137 A1
(43) Pub. Date: Jun. 24, 2021

(54) VEHICLE SEAT SUPPORT STRUCTURE

(71) Applicant: Nissan North America, Inc., Franklin, TN (US)

(72) Inventor: Daniel MARTINEZ CORONA, Mexico City (MX)

(21) Appl. No.: 16/721,405

(22) Filed: Dec. 19, 2019

(51) Int. Cl. B60N 2/28; B60N 2/015

(52) U.S. Cl. CPC B60N 2/2887; B60N 2/015

(57) ABSTRACT

A vehicle seat support structure includes a vehicle body structure, a support frame of a seat assembly and a support bracket. The vehicle body structure has a floor that at least partially defines a passenger compartment. The support frame of the seat assembly is installed to the vehicle body structure such that at least a portion of the support frame overlays the floor. The support bracket has a pair of child seat attachment portions and a frame attachment portion. The support bracket is fixedly attached to the vehicle body structure with a portion of the support frame connected to the frame attachment portion.

### BACKGROUND

### Field of the Invention

The present invention generally relates to vehicle seat support structure. More specifically, the present invention relates to seat support structure that includes attachment locations on a rigid support bracket attached to the floor within a passenger compartment.

### Background Information

A rear seat assembly of passenger vehicle usually includes a cushion portion and a seatback or upright portion. The cushion portion is often installed to a passenger compartment floor via projections that are inserted into openings in the floor of the passenger compartment. A rear edge of the cushion portion is further tucked under a lower end of the seatback portion.

### SUMMARY

One object of the present disclosure is to provide a cushion portion of a rear seat assembly of a vehicle with attachment structures that secure the rear seat assembly to the vehicle regardless of whether or not the cushion portion contacts an upright portion of the rear seat assembly.

Another object of the present disclosure is to provide a cushion portion of a rear seat assembly with attachment structures that attached to brackets attached to the floor of the vehicle, the brackets further including child seat attachment portions.

In view of the state of the known technology, one aspect of the present disclosure is to provide a vehicle seat support structure with a vehicle body structure, a support frame and a support bracket. The vehicle body structure has a floor that at least partially defines a passenger compartment. The support frame of a seat assembly is installed to the vehicle body structure such that at least a portion of the support frame overlays the floor. The support bracket has a pair of child seat attachment portions and a frame attachment portion. The support bracket is fixedly attached to the vehicle body structure with a portion of the support frame connected to the frame attachment portion.

### BRIEF DESCRIPTION OF THE DRAWINGS

Referring now to the attached drawings which form a part of this original disclosure:

FIG. 1 is a perspective view of a vehicle that includes a vehicle seat support structure in accordance with one embodiment;

FIG. 2 is a perspective view of a portion of a passenger compartment of the vehicle depicted in FIG. 1, showing floor, a cushion portion of a rear seat assembly attached to the floor and support brackets attached to the floor in accordance with the one embodiment;

FIG. 3 is another perspective view of the portion of a passenger compartment depicted in FIG. 2, of the floor, a frame of the cushion portion with cushioning material and cover removed, showing the frame attached to the floor and the support brackets in accordance with the one embodiment;

FIG. 4 is a perspective view of the frame removed from the cushion portion and the vehicle in accordance with the one embodiment;

FIG. 5 is a top view of the cushion portion and support brackets depicted in FIG. 2 shown removed from the vehicle in accordance with the one embodiment;

FIG. 6 is a perspective view of one of the support brackets and a hook shaped bracket thereof depicted in FIG. 5 shown removed from the vehicle in accordance with the one embodiment; and

FIG. 7 is a perspective view of a hook shaped bracket shown removed from the support bracket in accordance with the one embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

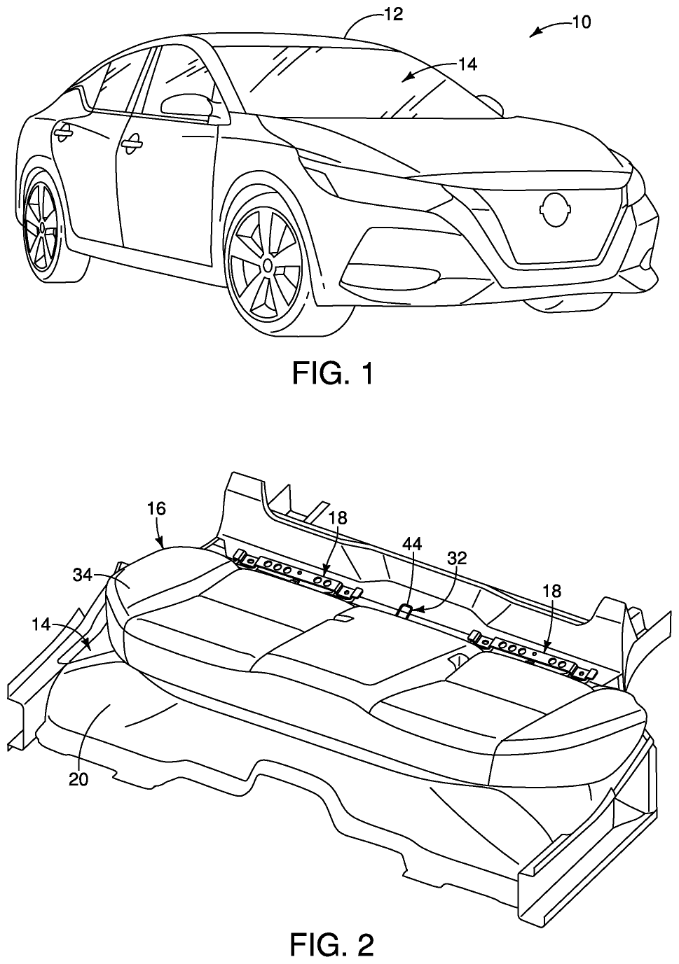

Referring initially to FIG. 1, a vehicle 10 is illustrated in accordance with a first embodiment. As shown in FIG. 2, the vehicle 10 includes a vehicle body structure 12 that defines a passenger compartment 14 with a rear seat assembly 16 retained therein by, among other structures, a support bracket 18.

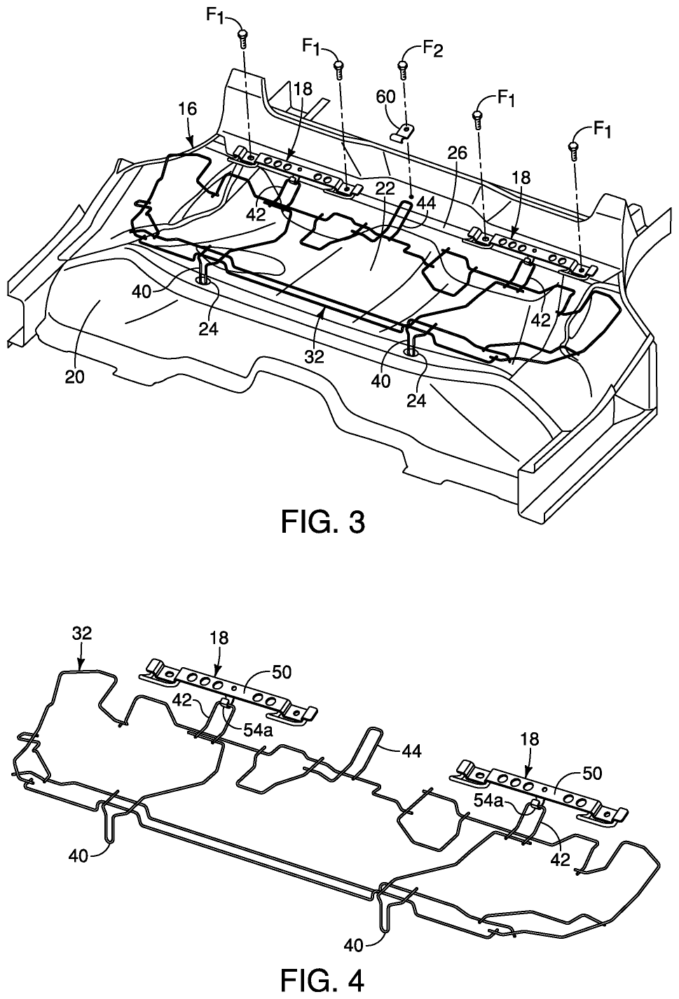

The vehicle body structure 12 includes a floor 20 that at least partially defines the passenger compartment 14. The floor 20 includes a seat supporting portion 22. The seat supporting portion 22 includes a pair of recesses 24 (FIG. 3) and an inclined surface 26 rearward of the seat supporting portion 22. Since vehicle body structures and passenger compartments are conventional vehicle structures, further description is omitted for the sake of brevity.

The rear seat assembly 16 includes a cushion portion 30 and an upright portion (not shown). The upright portion is configured and dimensioned to support a torso portion of a passenger (not shown). The cushion portion 30 includes a support frame 32 (FIGS. 3 and 4), cushion material (not shown) and a cover 34 (FIG. 2).

A description of the support frame 32 of the seat assembly 16 is now described with specific reference to FIGS. 3 and 4. The support frame 32 is basically a wire frame assembly (also designated with reference number 32) constructed using, for example heavy gauge wire material that is bent, shaped and welded together to define a basic frame such as that shown in FIGS. 3 and 4. It should be understood from the drawings and the description herein that the shape of the wire frame assembly 32 depicted in FIGS. 3 and 4 can be modified or formed with a completely different overall shape, so long as the wire frame assembly 32 includes attachment areas that are described hereinbelow. Further, the wire frame assembly 32 is configured and shaped to support, for example, textile or textile-like strapping, springs and cushion material (not shown) that is used to provide the overall shape of the seat assembly 16. Once the textile or textile-like strapping, springs and cushion material are attached to the wire frame assembly 32, the cover 34 is installed concealing the wire frame assembly 32, the textile or textile-like strapping, springs and cushion material.

The wire frame assembly 32 is installed to the vehicle body structure 12 such that at least a portion of the support frame 32 (the wire frame assembly 32) overlays the seat supporting portion 22 of the floor 20, the seat supporting portion 22 being located at a rear area of the floor 20 within the passenger compartment 14.

The wire frame assembly 32 includes a pair of front attachment projections 40 that are spaced apart from one another, a pair of rear attachment loops 42 that are also spaced apart from one another and a central loop or central attachment section 44.

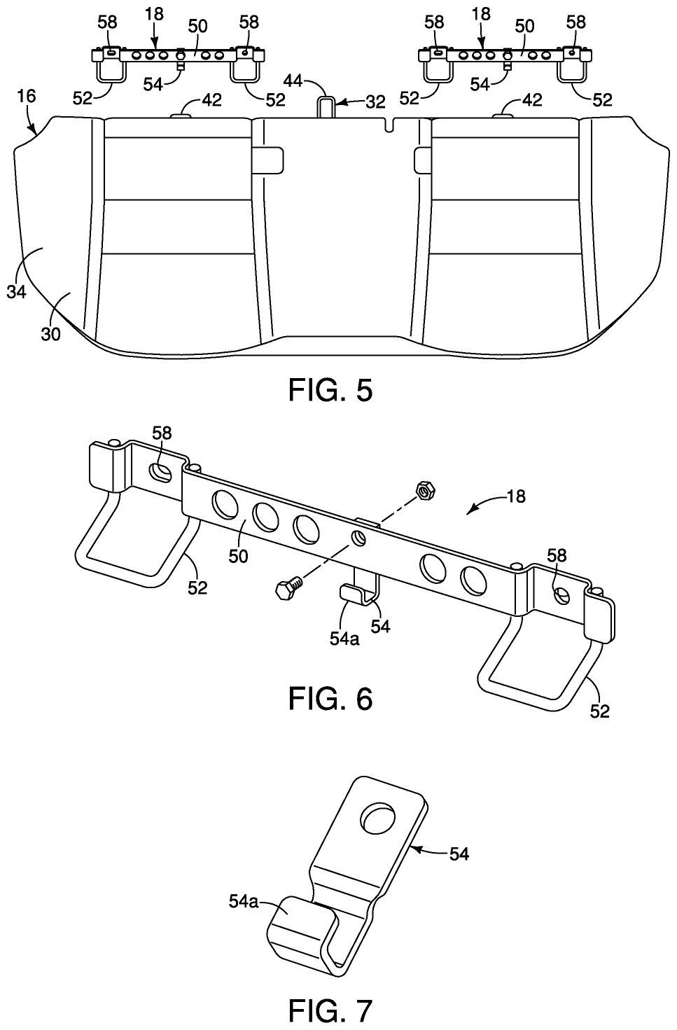

As shown in FIGS. 2-5, there are two support brackets 18 that are basically identical to one another. Therefore, description of one of the support brackets 18 applies equally to both support brackets. The support bracket 18 is fixedly attached to the floor 20 along the inclined surface 26, as shown in FIGS. 2 and 3. As shown in FIGS. 5 and 6, the support bracket 18 includes an elongated metallic plate 50, a pair of child seat attachment portions 52 and a frame attachment portion 54.

The support bracket 18 includes an elongated metallic plate 50 is shown in the depicted embodiment as a flat metallic plate that includes contoured portions and openings for weight reduction. The pair of child seat attachment portions 52 are attached to the support bracket 18, with one of child seat attachment portions 52 installed at an inboard end of the elongated metallic plate 50 and the other of the child seat attachment portions 52 being installed to an outboard end of the elongated metallic plate 50. The child seat attachment portion 52 are basically metallic U-shaped members made of heavy gauge wire bent into a U-shape and then welded to the corresponding end of the elongated metallic plate 50. The child seat attachment portions 52 designed, shaped and positioned such that they are easily accessed by a passenger or vehicle operator such that a child seat can be attached or tethered thereto in a conventional manner. Since child seat attachment structures are conventional vehicle structures, further description is omitted for the sake of brevity.

The frame attachment portion 54 is basically a metal plate that is bent in order to define a hook 54a, as shown in FIG. 7. The frame attachment portion 54 and the hook 54a is also referred to herein as a hook shaped projection of the support bracket 18. In the depicted embodiment, the frame attachment portion 54 is fastened to a central area of the support bracket 18 via a mechanical fastener. Alternatively, the frame attachment portion 54 can be welded to the elongated metallic plate 50 or formed therewith.

As shown in FIG. 3, the support brackets 18 are fixedly attached to the floor 20 via mechanical fasteners F₁.

When the cushion portion 30 of the rear seat assembly 16 is installed to the floor 20, the front attachment projections 40 are installed to respective ones of the recesses 24, as shown in FIG. 3. The recesses 24 are also referred to as recessed areas of the floor 20. The rear attachment loops 42 are attached to the hooks 54a of respective ones of the support brackets 18 between corresponding ones of the child seat attachment portions 52. Further, the central attachment section 44 of the wire frame assembly 32 is directly fixed to inclined surface 26 of the floor 20 via a clamp 60 and fastener F₂, as shown in FIG. 3. Alternatively, the clamp 60 can be replaced with a hook similar to the hook 54a, that is welded to the floor 20.

As shown in FIG. 3, the support frame 32 (the wire frame assembly 32) of the cushion portion 30 of the rear seat assembly 16 is attached to the floor 20 at five different locations. Specifically, the support frame 32 (and hence the seat cushion portion 30) is attached to the floor 20 via: the two front attachment projections 40 being inserted into the two recesses 24; the rear attachment loops 42 being hooked onto the hooks 54a of the two support bracket 18; and the central attachment section being hooked and/or clamped to the clamp 60.

Hence, the cushion portion 30 of the rear seat assembly 16 is securely and more reliably attached to the floor 20, as compared to other cushion assembly installation configurations.

The various vehicle structures, features and components, other than the rear seat assembly 16 and the support brackets 18, are conventional components that are well known in the art. Since such structures, features and components are well known in the art, these structures will not be discussed or illustrated in detail herein. Rather, it will be apparent to those skilled in the art from this disclosure that the components can be any type of structure and/or programming that can be used to carry out the present invention.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle seat support structure. Accordingly, these terms, as utilized to describe the present invention should be interpreted relative to a vehicle equipped with the vehicle seat support structure.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A vehicle seat support structure, comprising:
a vehicle body structure having a floor that at least partially defines a passenger compartment;
a support frame of a seat assembly installed to the vehicle body structure such that at least a portion of the support frame overlays the floor; and
a support bracket having a pair of child seat attachment portions and a frame attachment portion, the support bracket being fixedly attached to the vehicle body structure with a portion of the support frame connected to the frame attachment portion.

2. The vehicle seat support structure according to claim 1, wherein
the support bracket includes an elongated metallic plate with the pair of child seat attachment portions extending from opposite ends thereof.

3. The vehicle seat support structure according to claim 2, wherein
the frame attachment portion extends from a central portion of the elongated metallic plate between the pair of child seat attachment portions.

4. The vehicle seat support structure according to claim 3, wherein
the frame attachment portion includes a hook shaped projection.

5. The vehicle seat support structure according to claim 1, wherein
the frame attachment portion extends from a central portion of the support bracket between the pair of child seat attachment portions.

6. The vehicle seat support structure according to claim 1, wherein
the support bracket includes an elongated metallic plate with the frame attachment portion extending from a central portion of the elongated plate.

7. The vehicle seat support structure according to claim 6, wherein
the frame attachment portion includes a hook shaped projection extending from a central portion of the elongated metallic plate between the child seat attachment portions.

8. The vehicle seat support structure according to claim 1, wherein
the support frame of the seat assembly is installed to a rear area of the floor within the passenger compartment.

9. The vehicle seat support structure according to claim 1, wherein
the support frame is a wire frame assembly.

10. The vehicle seat support structure according to claim 9, wherein
the wire frame assembly includes a pair of spaced apart front attachment projection that are installed to respective recessed areas of the floor.

11. The vehicle seat support structure according to claim 10, wherein
the wire frame assembly includes a rear central attachment section that is directly fixed to the floor.

12. The vehicle seat support structure according to claim 9, wherein
the support bracket includes an elongated metallic plate with the pair of child seat attachment portions extending from opposite ends thereof.

13. The vehicle seat support structure according to claim 12, wherein
the frame attachment portion extends from a central portion of the elongated metallic plate between the pair of child seat attachment portions.

14. The vehicle seat support structure according to claim 13, wherein
the frame attachment portion includes a hook shaped projection with an adjacent section of the wire frame assembly attached to the hook shaped projection.

15. The vehicle seat support structure according to claim 9, wherein
the support bracket includes an elongated metallic plate with the frame attachment portion extending from a central portion of the elongated plate with an adjacent section of the wire frame assembly attached to the hook shaped projection.

16. The vehicle seat support structure according to claim 15, wherein
the wire frame assembly includes a central attachment section that is directly fixed to the floor.
